(19) United States
(12) Patent Application Publication
(10) Pub. No.: US 2024/0157938 A1
(43) Pub. Date: May 16, 2024

(54) DRIVING ASSISTANCE APPARATUS

(71) Applicant: TOYOTA JIDOSHA KABUSHIKI KAISHA, Toyota-shi (JP)

(72) Inventor: Yoshinari TODA, Nisshin-shi (JP)

(73) Assignee: TOYOTA JIDOSHA KABUSHIKI KAISHA, Toyota-shi (JP)

(21) Appl. No.: 18/496,169

(22) Filed: Oct. 27, 2023

(30) Foreign Application Priority Data
Nov. 14, 2022 (JP) 2022-182019

(51) Int. Cl. B60W 30/14; B60W 50/14

(52) U.S. Cl. CPC B60W 30/146; B60W 50/14; B60W 2554/4042; B60W 2554/802

(57) ABSTRACT

A driving assistance apparatus includes a tollgate type determiner and a travel controller. The tollgate type determiner determines whether or not a tollgate present in front of a vehicle is a speed-limit tollgate, on the basis of positional information on the vehicle and map information. The travel controller controls a travel speed of the vehicle in accordance with the result of determination by the tollgate type determiner. When the tollgate is the speed-limit tollgate, the travel controller performs speed-limiting control such that, while passing through the tollgate, the vehicle has the travel speed limited not more than a speed limit for the speed-limit tollgate. When the tollgate is not the speed-limit tollgate, the travel controller does not perform the speed-limiting control.

### TECHNICAL FIELD

The present disclosure relates to a driving assistance apparatus.

### BACKGROUND

Conventionally, Japanese Unexamined Patent Publication No. 2018-83538 is known as a technical document related to a driving assistance apparatus. Japanese Unexamined Patent Publication No. 2018-83538 discloses a technique of reducing, for example, the travel speed of a vehicle by the execution of a tollgate pass mode when a tollgate is present in front of the vehicle.

### SUMMARY

However, if the tollgate pass mode is uniformly executed due to the presence of a tollgate in front of the vehicle, any occupant of the vehicle may feel strange, for example, when speed limit is not set for the tollgate.

An object of the present disclosure is to provide a driving assistance apparatus that enables a reduction in an occupant's feeling of strangeness to driving assistance at the time of passage through a tollgate.

A driving assistance apparatus according to the present disclosure is a driving assistance apparatus for assisting driving of a vehicle, and the driving assistance apparatus includes: a tollgate type determiner configured to determine whether or not a tollgate present in front of the vehicle is a speed-limit tollgate, based on positional information on the vehicle and map information; and a travel controller configured to control a travel speed of the vehicle in accordance with a result of determination by the tollgate type determiner, in which when the tollgate is the speed-limit tollgate, the travel controller performs speed-limiting control such that, while passing through the tollgate, the vehicle has the travel speed limited not more than a speed limit for the speed-limit tollgate, or when the tollgate is not the speed-limit tollgate, the travel controller does not perform the speed-limiting control.

According to the present disclosure, provided can be a driving assistance apparatus that enables a reduction in an occupant's feeling of strangeness to driving assistance at the time of passage through a tollgate.

### BRIEF DESCRIPTION OF THE DRAWINGS

FIG. 1 is a block diagram of a driving assistance apparatus of an embodiment;

FIG. 2A shows driving assistance control corresponding to a type of tollgate;

FIG. 2B shows driving assistance control corresponding to a type of tollgate;

FIG. 3A is a display image corresponding to a type of tollgate;

FIG. 3B is a display image corresponding to a type of tollgate; and

FIG. 4 is a flowchart of processing by the driving assistance apparatus shown in FIG. 1.

### DETAILED DESCRIPTION

Hereinafter, embodiments of the present disclosure will be described with reference to the drawings.

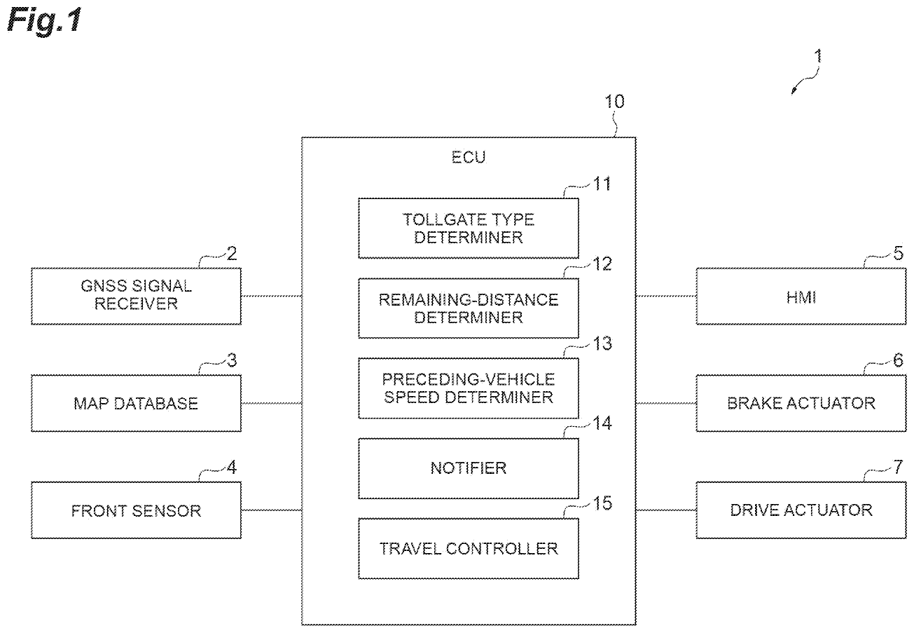

FIG. 1 is a block diagram of a driving assistance apparatus of an embodiment. As shown in FIG. 1, a driving assistance apparatus 1 includes a global navigation satellite system (GNSS) signal receiver 2, map database 3, a front sensor 4, a human machine interface (HMI) 5, a brake actuator 6, a drive actuator 7, and an electronic control unit (ECU) 10. The driving assistance apparatus 1 assists driving of a vehicle.

The GNSS signal receiver 2 receives a signal from a positioning satellite to measure the position of the vehicle (e.g., the latitude and longitude of the vehicle). The GNSS signal receiver 2 transmits the positional information on the vehicle to the ECU 10.

The map database 3 is a database that stores map information. The map database 3 is provided in a server communicable with the vehicle. The map information includes, for example, information on roads and intersections. The map information includes information on the positions and types of tollgates. The map database 3 may be provided in a storage device such as a vehicle-mounted hard disk drive (HDD).

The front sensor 4 includes at least one of a camera and a radar sensor. The camera is an image capturing device that performs front capturing with respect to a vehicle. The camera transmits a captured image to the ECU 10. The camera is, for example, a monocular camera or a stereo camera. The radar sensor is a detecting device based on radio waves (e.g., millimeter waves) or light. The radar sensor includes, for example, a millimeter-wave radar or a laser imaging detection and ranging (LIDAR). The radar sensor transmits radio waves or light to the periphery of the vehicle and receives radio waves or light reflected from an object to detect the object. The front sensor 4 detects, for example, the travel speed of the preceding vehicle. The front sensor 4 transmits the result of detection to the ECU 10.

The HMI 5 is an interface for input and output of information between the vehicle and an occupant of the vehicle in response to a control signal from the ECU 10. The HMI 5 includes, for example, a display or a speaker. The HMI 5 provides a notification to the occupant. The HMI 5 notifies the occupant of the front conditions of the vehicle, for example. The HMI 5 notifies the occupant of prompting a brake operation, for example.

The brake actuator 6 controls the braking force of the vehicle in response to a control signal from the ECU 10. Specifically, the brake actuator 6 controls the brake system to control a braking force to be given to a wheel of the vehicle. The brake system is, for example, a hydraulic brake system.

The drive actuator 7 controls the driving force of a power source of the vehicle in response to a control signal from the ECU 10. Specifically, the drive actuator 7 controls the amount of air supply to the engine (throttle opening) to control the driving force of the vehicle. When the vehicle is a hybrid electric vehicle (HEV), a control signal from the ECU 10 is input to the motor as a power source to control the driving force, in addition to the control of the amount of air supply. When the vehicle is a battery electric vehicle (BEV), a control signal from the ECU 10 is input to the motor as a power source to control the driving force. The motor as a power source in these cases is included in the drive actuator 7.

The ECU 10 is an electronic control unit including a central processing unit (CPU) and a memory such as a read only memory (ROM) or a random access memory (RAM). In the ECU 10, for example, the CPU executes a program stored in the memory to achieve various functions. The ECU 10 is provided, for example, in the vehicle.

The ECU 10 includes, as functional components, a tollgate type determiner 11, a remaining-distance determiner 12, a preceding-vehicle speed determiner 13, a notifier 14, and a travel controller 15. The tollgate type determiner 11 determines the type of a tollgate present in front of the vehicle. The travel controller 15 assists driving in accordance with the type of the tollgate.

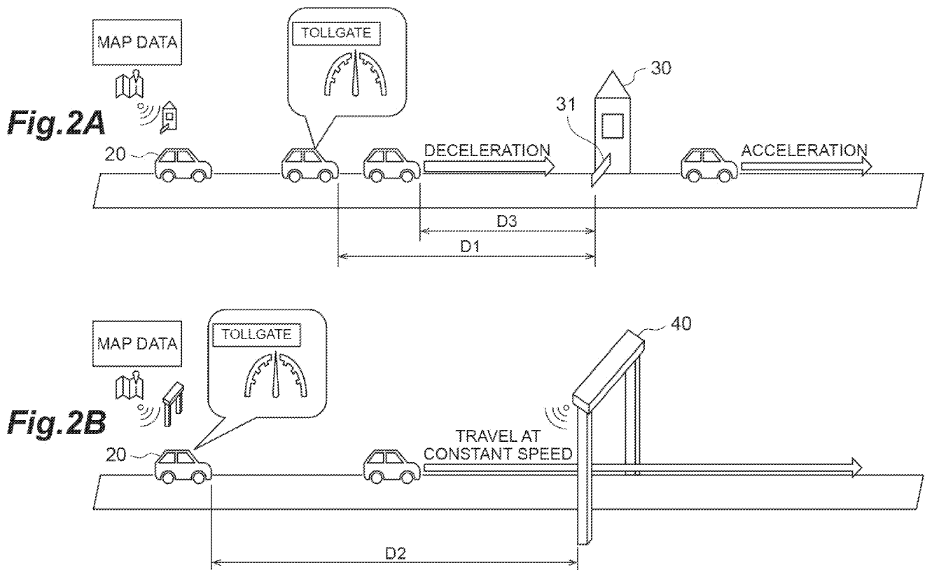

FIG. 2A and FIG. 2B show driving assistance control corresponding to a type of tollgate. FIG. 2A shows the presence of a tollgate 30 in front of a vehicle 20. The tollgate 30 is a speed-limit tollgate. A speed-limit tollgate refers to a tollgate to which a speed limit is set by a country, a local government, or a road management association. The tollgate 30 includes an open/close mechanism 31 for permission or prohibition of the passage of the vehicle 20. The open/close mechanism 31 includes, for example, a bar. With the open/close mechanism 31 remaining open, the passage of the vehicle 20 is permitted. With the open/close mechanism 31 remaining closed, the passage of the vehicle 20 is prohibited.

The speed limit for the tollgate 30 is, for example, not more than 20 km/h. Namely, the travel speed of the vehicle 20 while passing through the tollgate 30 is limited not more than 20 km/h. When the travel speed of the vehicle 20 is larger than the speed limit for the tollgate 30, the vehicle 20 starts deceleration before passing through the tollgate 30 and accelerates after passing through the tollgate 30, for example.

When the speed limit for the tollgate 30 is prescribed in advance by the country, the local government, or the road management association, a fixed value stored, in advance, in accordance with the type of the tollgate 30 is adopted. The speed limit for the tollgate 30 may be stored in advance in association with the tollgate 30 in the map information. For recognition of the speed limit for the tollgate 30, a guide plate or a sign with the speed limit for the tollgate 30 indicated at a position that is closer to the vehicle 20 than the tollgate 30 is may be image captured by the camera of the vehicle 20. The speed limit may be a value set by the driving assistance apparatus 1 so as to be less than a regulatory speed prescribed by the country, the local government, or the road management association.

FIG. 2B shows the presence of a tollgate 40 in front of the vehicle 20. The tollgate 40 is not a speed-limit tollgate. The tollgate 40 is a no-speed-limit tollgate. A no-speed-limit tollgate refers to a tollgate to which a speed limit is not set by the country, the local government, or the road management association. The tollgate 40 does not include an open/close mechanism or the like for permission or prohibition of the passage of the vehicle 20. The tollgate 40 is kept open. The vehicle 20 can pass through the tollgate 40 any time.

The vehicle 20 can pass through the tollgate 40 at a speed within the range of speed limit set for the road. The vehicle 20 may not decelerate before passing through the tollgate 40. The vehicle 20 may pass through the tollgate 40 while traveling at a constant speed.

The tollgate type determiner 11 determines whether or not a tollgate is present in front of the vehicle 20, on the basis of the positional information on the vehicle 20 transmitted from the GNSS signal receiver 2 and the map information of the map database 3. When a tollgate is present on the route of the vehicle 20, the tollgate type determiner 11 determines whether or not the tollgate is a speed-limit tollgate, on the basis of the positional information on the vehicle 20 and the map information of the map database 3.

Examples of systems of the tollgate include fixed toll collection, pre-purchase, ticket purchase, and electronic toll collection. Examples of systems of the tollgate include cash payment, bank card payment, credit card payment, toll ticket payment (e.g., monthly payment), and on-board device payment. The tollgate type determiner 11 determines whether or not the tollgate is a speed-limit tollgate, on the basis of these various pieces of information included in the map information.

As an example, when the tollgate adopts the systems of electronic toll collection and on-board device payment, the tollgate type determiner 11 determines that the tollgate is not a speed-limit tollgate. As an example, when the tollgate adopts the systems of fixed toll collection and cash payment, the tollgate type determiner 11 determines that the tollgate is a speed-limit tollgate. As an example, when the tollgate adopts the systems of electronic toll collection and cash payment, the tollgate type determiner 11 determines that it is unclear whether or not the tollgate is a speed-limit tollgate. In this case, the tollgate type determiner 11 provisionally determines that the tollgate is a speed-limit tollgate.

When the tollgate includes an open/close mechanism, the tollgate type determiner 11 may determine that the tollgate is a speed-limit tollgate. When the tollgate does not include an open/close mechanism, the tollgate type determiner 11 may determine that the tollgate is not a speed-limit tollgate. Whether or not the tollgate includes an open/close mechanism is determined on the basis of the map information. Whether or not the tollgate includes an open/close mechanism may be determined by image capturing by the camera of the vehicle 20.

The remaining-distance determiner 12 determines the remaining distance between the vehicle 20 and a tollgate on the basis of the positional information on the vehicle 20 transmitted from the GNSS signal receiver 2 and the map information of the map database 3.

The preceding-vehicle speed determiner 13 determines whether or not the preceding vehicle traveling to the tollgate has decelerated, on the basis of the result of detection by the front sensor 4. The preceding-vehicle speed determiner 13 determines whether or not the preceding vehicle has decelerated from a speed larger than the speed limit for the tollgate 30 (hereinafter, simply referred to as “speed limit”) to a speed not more than the speed limit.

The notifier 14 issues a tollgate notification indicating the presence of the tollgate to the occupant of the vehicle 20, on the basis of the remaining distance determined by the remaining-distance determiner 12. The notifier 14 causes the HMI 5 to output the tollgate notification. The HMI 5 outputs the tollgate notification, for example, through a display.

When the tollgate 30 (speed-limit tollgate) is present in front of the vehicle 20, the notifier 14 issues a first tollgate notification at the timing at which the remaining distance between the vehicle 20 and the tollgate 30 reaches a first distance D1 (e.g., about 300 m). The notifier 14 issues a notification of the presence of the tollgate 30 as the first tollgate notification.

When the tollgate 40 (no-speed-limit tollgate) is present in front of the vehicle 20, the notifier 14 issues a second tollgate notification at the timing at which the remaining distance between the vehicle 20 and the tollgate 40 reaches a second distance D2 (e.g., about 400 m). The notifier 14 issues a notification of the presence of the tollgate 40 as the second tollgate notification.

The second distance D2 is larger than the first distance D1. Namely, when the tollgate 40 is present in front of the vehicle 20, the notifier 14 issues a tollgate notification earlier as compared to when the tollgate 30 is present in front of the vehicle 20.

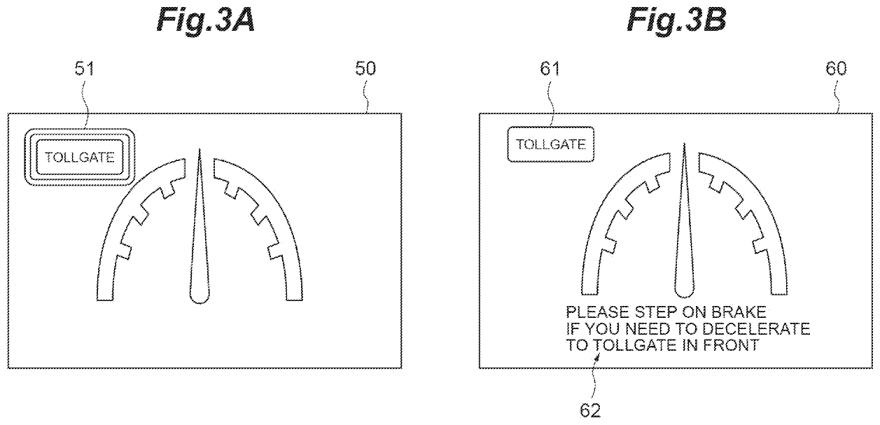

FIG. 3A is a display image, on the display (meter display), corresponding to the first tollgate notification. As shown in FIG. 3A, a display image 50 includes an icon 51 located next to the vehicle speed meter. The icon 51 indicates the presence of the tollgate 30. The icon 51 includes characters such as “TOLLGATE”.

FIG. 3B is a display image, on the display (meter display), corresponding to the second tollgate notification. As shown in FIG. 3B, a display image 60 includes an icon 61 located next to the vehicle speed meter and a text 62 located below the vehicle speed meter. The icon 61 indicates the presence of the tollgate 40. The icon 61 includes characters such as “TOLLGATE”. The text 62 includes characters such as “Please step on the brake if you need to decelerate to the tollgate in front”. The second tollgate notification issued by the notifier 14 includes a notification with the text 62 indicating that speed-limiting control described later is not to be performed.

The travel controller 15 controls the travel speed of the vehicle 20 in accordance with the result of determination by the tollgate type determiner 11. When the tollgate 30 (speed-limit tollgate) is present in front of the vehicle 20, the travel controller 15 performs speed-limiting control such that, while passing through the tollgate 30, the vehicle 20 has a travel speed limited not more than the speed limit for the tollgate 30.

When the travel speed of the vehicle 20 is larger than the speed limit for the tollgate 30, the travel controller 15 transmits a control signal to the brake actuator 6 to decrease the travel speed of the vehicle 20 to the speed not more than the speed limit for the tollgate 30. When the travel speed of the vehicle 20 is not more than the speed limit for the tollgate 30, the travel controller 15 maintains the travel speed of the vehicle 20. As long as the travel speed of the vehicle 20 is within the range of the speed limit for the tollgate 30, the travel controller 15 may transmit a control signal to the drive actuator 7 to increase the travel speed of the vehicle 20.

The travel controller 15 keeps the speed-limiting control until the vehicle 20 passes through the tollgate 30. The travel controller 15 stops the speed-limiting control after the vehicle 20 passes through the tollgate 30. After the vehicle 20 passes through the tollgate 30, the travel controller 15 may transmit a control signal to the drive actuator 7 to increase the travel speed of the vehicle 20.

The travel controller 15 performs speed-limiting control at the timing at which the remaining distance between the vehicle 20 and the tollgate 30 reaches a third distance D3 (see FIG. 2A). The third distance D3 is smaller than the first distance D1. That is, the travel controller 15 performs the speed-limiting control after the notifier 14 issues the first tollgate notification.

When the tollgate 40 (no-speed-limit tollgate) is present in front of the vehicle 20, the travel controller 15 does not perform speed-limiting control. The travel controller 15 maintains the travel speed of the vehicle 20 constant, for example.

In the presence of the tollgate 40 in front of the vehicle 20, when the preceding vehicle is present in front of the vehicle 20 and the preceding vehicle has decelerated from a speed larger than the speed limit to a speed not more than the speed limit, the travel controller 15 performs speed-limiting control. When the preceding vehicle is decelerating, there is a possibility that not the tollgate 40 but the tollgate 30 is present in front of the vehicle 20.

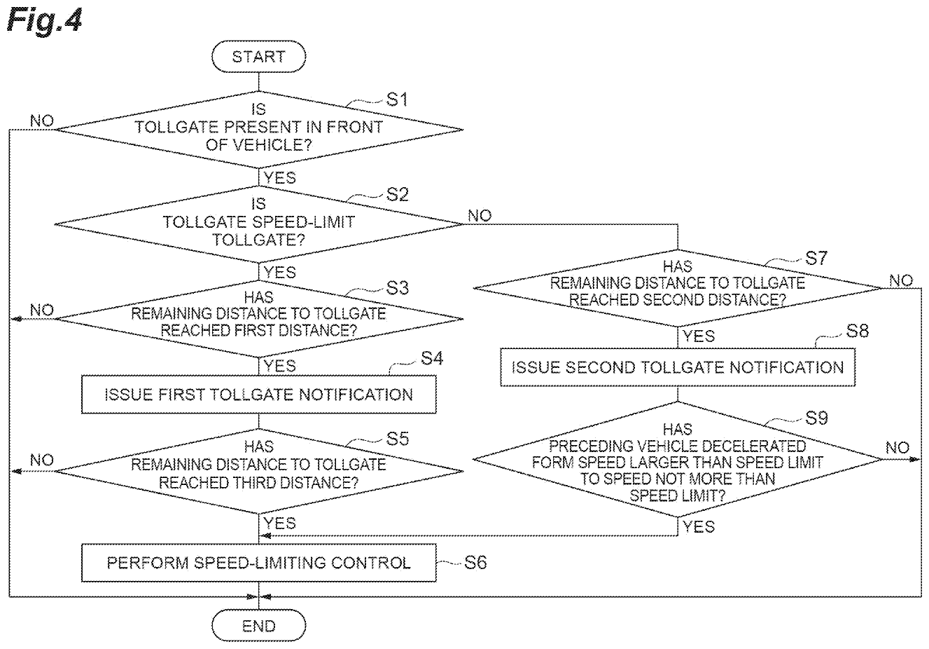

Next, processing of the ECU 10 will be described. FIG. 4 is a flowchart of processing by the driving assistance apparatus 1. As shown in FIG. 4, in step S1, the ECU 10 determines whether or not a tollgate is present in front of the vehicle 20.

When a tollgate is present in front of the vehicle 20 (step S1: YES), the ECU 10 proceeds to step S2. When no tollgate is present in front of the vehicle 20 (step S1: NO), the ECU 10 ends the current processing.

In step S2, the ECU 10 determines whether or not the tollgate is a speed-limit tollgate (tollgate 30). When the tollgate is a speed-limit tollgate (step S2: YES), the ECU 10 proceeds to step S3. When the tollgate is not a speed-limit tollgate (step S2: NO), the ECU 10 proceeds to step S7.

In step S3, the ECU 10 determines whether or not the remaining distance to the tollgate has reached a first distance D1. When the remaining distance has reached a first distance D1 (step S3: YES), the ECU 10 proceeds to step S4. When the remaining distance has not reached a first distance D1 (step S3: NO), the ECU 10 ends the current processing. In step S4, the ECU 10 issues a first tollgate notification.

In step S5, the ECU 10 determines whether or not the remaining distance to the tollgate has reached a third distance D3. When the remaining distance has reached a third distance D3 (step S5: YES), the ECU 10 proceeds to step S6. When the remaining distance has not reached a third distance D3 (step S5: NO), the ECU 10 ends the current processing. In step S6, the ECU 10 performs speed-limiting control.

In step S7, the ECU 10 determines whether or not the remaining distance to the tollgate has reached a second distance D2. When the remaining distance has reached a second distance D2 (step S7: YES), the ECU 10 proceeds to step S8. When the remaining distance has not reached a second distance D2 (step S7: NO), the ECU 10 ends the current processing. In step S8, the ECU 10 issues a second tollgate notification.

In step S9, the ECU 10 determines whether or not the preceding vehicle has decelerated from a speed larger than the speed limit to a speed not more than the speed limit. When the preceding vehicle has decelerated from a speed larger than the speed limit to a speed not more than the speed limit (step S9: YES), the ECU 10 proceeds to step S6. When the preceding vehicle has not decelerated from a speed larger than the speed limit to a speed not more than the speed limit (step S9: NO), the ECU 10 ends the current processing.

As described above, the travel controller 15 performs speed-limiting control when the tollgate is a speed-limit tollgate, and does not perform speed-limiting control when the tollgate is not a speed-limit tollgate. As a result, the travel speed of the vehicle 20 is not limited when the tollgate is not a speed-limit tollgate. Thus, an occupant's feeling of strangeness to the driving assistance at the time of passage through the tollgate is reduced as compared to, for example, when speed-limiting control is performed regardless of the type of the tollgate. Further, because the travel speed of the vehicle 20 is not limited when the tollgate is not a speed-limit tollgate, collision with the following vehicle due to deceleration of the vehicle 20 is inhibited and botheration of the occupant is reduced.

The driving assistance apparatus 1 includes the remaining-distance determiner 12 and the notifier 14. The remaining-distance determiner 12 determines the remaining distance between the vehicle 20 and the tollgate, on the basis of the positional information on the vehicle 20 and the map information. The notifier 14 issues a tollgate notification indicating the presence of the tollgate to the occupant of the vehicle 20, on the basis of the remaining distance. When the tollgate is a speed-limit tollgate, the notifier 14 issues a first tollgate notification at the timing at which the remaining distance reaches a first distance D1. When the tollgate is not a speed-limit tollgate, the notifier 14 issues a second tollgate notification at the timing at which the remaining distance reaches a second distance D2. The second distance D2 is larger than the first distance D1. As a result, when the tollgate is not a speed-limit tollgate, a tollgate notification issued earlier as compared to when the tollgate is a speed-limit tollgate. Thus, an occupant's feeling ofuneasiness while the vehicle 20 is passing through the tollgate without speed-limiting control is reduced.

The second tollgate notification issued by the notifier 14 includes a notification indicating that speed-limiting control is not to be performed. As a result, an occupant's feeling of uneasiness while the vehicle 20 is passing through the tollgate without speed-limiting control is reduced.

The driving assistance apparatus 1 includes the preceding-vehicle speed determiner 13. The preceding-vehicle speed determiner 13 determines whether or not the preceding vehicle traveling to the tollgate has decelerated from a speed larger than the speed limit to a speed not more than the speed limit, on the basis of the result of detection by the front sensor 4 of the vehicle 20. When the tollgate is not a speed-limit tollgate and the preceding vehicle has decelerated to a speed not more than the speed limit, the travel controller 15 performs speed-limiting control. As a result, even when the tollgate is not a speed-limit tollgate, speed-limiting control is performed when there is a possibility of erroneous determination of the type of the tollgate due to, for example, a delay in update of the map information. Thus, an occupant's feeding of uneasiness is reduced. When update of the map information is delayed, there is a possibility that the tollgate type determiner 11 erroneously determines, for example, the speed-limit tollgate as a no-speed-limit tollgate.

Although the embodiments of the present disclosure have been described above, the present disclosure is not limited to the embodiments. The present disclosure can be implemented in various forms with various modifications and improvements on the basis of knowledge of those skilled in the art, including the embodiments.

The driving assistance apparatus 1 may not include the remaining-distance determiner 12, the preceding-vehicle speed determiner 13, and the notifier 14. The notifier 14 may not issue a notification indicating that speed-limiting control is not to be performed.

The tollgate type determiner 11 may determine the type of a tollgate on the basis of, for example, the result of detection by the front sensor in addition to the map information. In this case, the tollgate type determiner 11 recognizes the type of the tollgate appearing in an image captured by the camera of the front sensor 4, by a well-known image processing technique such as edge extraction, noise removal, pattern matching, or deep learning. The tollgate type determiner 11 may determine the type of a tollgate on the basis of, for example, a signal transmitted from the tollgate in addition to the map information. In these cases, for example, erroneous determination of the type of the tollgate due to a delay in update of the map information is inhibited.

The HMI 5 may output a tollgate notification or the like through a speaker, for example. The vehicle 20 may be an automated driving vehicle.

### REFERENCE SIGNS LIST

1 Driving assistance apparatus
4 Front sensor
11 Tollgate type determiner
12 Remaining-distance determiner
13 Preceding-vehicle speed determiner
14 Notifier
15 Travel controller
20 Vehicle
30, 40 Tollgate
D1 First distance
D2 Second distance

What is claimed is:

1. A driving assistance apparatus for assisting driving of a vehicle, the driving assistance apparatus comprising:
a tollgate type determiner configured to determine whether or not a tollgate present in front of the vehicle is a speed-limit tollgate, based on positional information on the vehicle and map information; and
a travel controller configured to control a travel speed of the vehicle in accordance with a result of determination by the tollgate type determiner, wherein
when the tollgate is the speed-limit tollgate, the travel controller performs speed-limiting control such that, while passing through the tollgate, the vehicle has the travel speed limited not more than a speed limit for the speed-limit tollgate, or
when the tollgate is not the speed-limit tollgate, the travel controller does not perform the speed-limiting control.

2. The driving assistance apparatus according to claim 1, further comprising:
a remaining-distance determiner configured to determine a remaining distance between the vehicle and the tollgate, based on the positional information on the vehicle and the map information; and
a notifier configured to issue a tollgate notification indicating presence of the tollgate to an occupant of the vehicle, based on the remaining distance, wherein
when the tollgate is the speed-limit tollgate, the notifier issues a first tollgate notification at a timing at which the remaining distance reaches a first distance, or
when the tollgate is not the speed-limit tollgate, the notifier issues a second tollgate notification at a timing at which the remaining distance reaches a second distance, and
the second distance is larger than the first distance.

3. The driving assistance apparatus according to claim 2, wherein the notifier issues a notification indicating that the speed-limiting control is not to be performed, in the second tollgate notification.

4. The driving assistance apparatus according to claim 1, further comprising
a preceding-vehicle speed determiner configured to determine, whether or not a preceding vehicle traveling to the tollgate has decelerated from a speed larger than the speed limit to a speed not more than the speed limit, based on a result of detection by a front sensor of the vehicle, wherein
when the tollgate is not the speed-limit tollgate and the preceding vehicle has decelerated to the speed not more than the speed limit, the travel controller performs the speed-limiting control.

5. The driving assistance apparatus according to claim 2, further comprising
a preceding-vehicle speed determiner configured to determine, whether or not a preceding vehicle traveling to the tollgate has decelerated from a speed larger than the speed limit to a speed not more than the speed limit, based on a result of detection by a front sensor of the vehicle, wherein
when the tollgate is not the speed-limit tollgate and the preceding vehicle has decelerated to the speed not more than the speed limit, the travel controller performs the speed-limiting control.

6. The driving assistance apparatus according to claim 3, further comprising
a preceding-vehicle speed determiner configured to determine, whether or not a preceding vehicle traveling to the tollgate has decelerated from a speed larger than the speed limit to a speed not more than the speed limit, based on a result of detection by a front sensor of the vehicle, wherein
when the tollgate is not the speed-limit tollgate and the preceding vehicle has decelerated to the speed not more than the speed limit, the travel controller performs the speed-limiting control.
